(19) United States
(12) Patent Application Publication
(10) Pub. No.: US 2019/0124891 A1
(43) Pub. Date: May 2, 2019

(54) PET ACCESSORY

(71) Applicant: Daniela SWINTON, West Meadows (AU)

(72) Inventors: Daniela SWINTON, West Meadows (AU); Ian SWINTON, West Meadows (AU); Patrick O'CONNELL, Footscray (AU); Andrea MILLER, Carnegie (AU)

(21) Appl. No.: 16/093,236

(22) PCT Filed: Apr. 28, 2017
(86) PCT No.: PCT/AU2017/050396

§ 371 Date: Oct. 12, 2018

(30) Foreign Application Priority Data
Apr. 28, 2016 (AU) 2016901565

(51) Int. Cl. A01K 27/00; A45C 13/30; A45C 11/24

(52) U.S. Cl. CPC A01K 27/008; A45C 11/24; A45C 13/30; A01K 27/003

(57) ABSTRACT

A pet accessory is disclosed and includes a strap, a bag and an attachment means that attaches the strap to the bag. The strap has sufficient length to be used as a leash and has a releasable catch at a first end for attaching the strap to a pet. The bag defines an interior volume for containing objects. The attachment means attaches the bag to the strap such that the pet accessory is adaptable to form a carry bag whereby the strap forms a handle or shoulder strap for carrying the bag and to form a pet leash with the bag attached and with the strap forming a hand loop in a portion of the strap opposite to the first end for restraining a pet.

### TECHNICAL FIELD

A pet accessory is disclosed. The pet accessory has application to dogs and has particular application as a restraint for walking a dog and to restraints for walking dogs. However, it will be appreciated that the scope of the disclosures is not limited to dogs. That is, although the following disclosures are made in the context of the pet accessory being used for dogs, the disclosure is to be broadly interpreted, in that the pet accessory may be used for other animals.

### BACKGROUND

In many places now, a person walking a dog is required to pick up any dog poo that their dog leaves on public areas, such as parks, walking trails, footpaths and beaches. The penalty for not picking up the dog poo is often a considerable monetary fine. Some local government authorities make dog poo bags (i.e. small plastic bags for containing a dog poo) available in parks and other public areas frequented by people walking dogs. However, dog poo bag dispensers are not located at each park or along each walking track. This means that people need to carry a supply of dog poo bags because they may not reach a dog poo bag dispenser during the course of the activity.

After picking up some dog poo in a dog poo bag, the person typically will place the loaded dog poo bag in the next conveniently located public rubbish bin. The act of carrying a loaded dog poo bag is unpleasant, even though the dog poo is generally securely held in the bag. The dog poo bags are generally formed of a thin plastic film which users may be anxious about breaking in the event the dog poo bag is not carried carefully. Moreover, it is difficult to carry a loaded dog poo bag in the hand without it being jostled and swung about by a person natural walking motions. The result is that the encapsulated poo can hit the user on the hand and wrist, thereby causing unpleasant sensations and making the person uncomfortable. These problems most likely contribute to some people who walk dogs refusing to pick up their dog's poo, even at the risk of a monetary fine.

There is a need, therefore, for an accessory that improves the convenience of carrying dog poo bags when empty or loaded.

### SUMMARY OF THE DISCLOSURE

There is disclosed in one aspect a pet accessory comprising:
(a) a strap having sufficient length to be used as a leash and having a releasable catch at a first end for attaching the strap to a pet; and
(b) a bag defining an interior volume for containing objects; and
(c) attachment means that is adapted to attach the bag to the strap such that the pet accessory is adaptable to form a carry bag whereby the strap forms a handle or shoulder strap for carrying the bag and to form a pet leash with the bag attached and with the strap forming a hand loop in a portion of the strap opposite to the first end for restraining a pet attached via the releasable catch.

Fitting the bag with the strap enables empty and loaded dog poo bags to be conveniently carried in the bag regardless of the form adopted for the pet accessory. Additionally, carrying loaded dog poo bags in the bag avoid the unpleasantness and discomfort outlined above. It also avoids anxious about breaking the dog poo bag in the event that it is not carried carefully. Moreover, the loaded dog poo bags can be carried in the bag of the pet accessory regardless of the form adopted for the pet accessory. All of these effects contribute to an overall improved convenience of carrying dog poo bags.

The ability of the pet accessory to transition between the carrier bag form and the pet leash form is advantageous for times when the dog is not on the leash, such as when the dog is in an off-leash area. That is, adopting the carry bag form enables the pet accessory to be slung over the shoulder and carried, thereby leaving both of the person's hands free for activities. However, when the dog and the person move out of the off-leash area, the carrier bag converts to the leash that is used to restrain the dog. That way, a separate leash and bag are not required.

It will be appreciated, therefore, that the dual functionality of the pet accessory simplifies the task of walking a dog by ensuring that dog poo bags are taken by the person on the walk, that loaded dog boo bags are carried without unpleasantness or concern and that the pet accessory can be carried in a way that reduces interference with the person's activities when the dog is off the leash.

In one embodiment, the strap may include a releasable catch at a second end and a clip point near the second end so that the releasable clip at the second end can hold the attachment means and the clip point simultaneously to form the hand loop of the pet leash.

The strap may be able to pass through the attachment means so that the clip point and the attachment means are able to be held by the releasable catch at the second end of the strap to form the pet leash and the releasable catches on the first end and the second end can be arranged to hold each other independent of the clip point and the attachment means to form the carry bag.

In another embodiment, the strap is a pet leash having a fixed loop handle at a second end and wherein the strap is able to pass through the attachment means such that the bag is attached to the pet leash and the accessory operates as a pet restraint and the releasable catch can be arranged to hold the fixed loop handle such that pet leash forms the handle or shoulder strap for carrying the bag.

In one form, the attachment means may comprise an endless ring that is fixed to the bag.

In another form, the attachment means may comprise an endless ring that is fixed to the bag and a support member. The support member may be a sleeve formed in the bag and through which sleeve the strap may be passed to suspend the bag from the strap. Alternatively, the support member may be another endless ring that is fixed to the bag and spaced from the other endless ring. In a further alternative, the support member may be press-studs or hook and loop fastener.

In another form, the attachment means may be a ring having an openable gate through which objects, such as the strap, may be passed to be contained within the ring.

In yet another form, the attachment means may be support member and a ring having an openable gate through which objects, such as the strap, may be passed to be contained within the ring. The support member may be a sleeve formed in the bag and through which sleeve the strap may be passed to suspend the bag from the strap. Alternatively, the support member may be another gated ring that is fixed to the bag and spaced from the other gated ring. In a further alternative, the support member may be press-studs or hook and loop fastener.

In another embodiment, the strap includes a first clip point at the second end and a second clip point near the second end and the attachment means is a releasable catch that is located to hold the second clip point so that, with the strap passed through the attachment means, the two clip points can be held by the releasable catch on the bag to form the hand loop of the pet leash and the releasable clip on the first end can hold the clip point on the second end to form the carry bag.

There is disclosed in another aspect a pet accessory comprising:
(a) a strap having sufficient length to be used as a leash; and
(b) a bag for containing objects; and

wherein the strap is fitted with the bag such that the pet accessory is adaptable to form a carry bag whereby the strap forms a loop for carrying the bag and to form a pet leash with a handle.

The strap may include releasable clips at each end so that the carrier bag can be formed by clipping the releasable clips together when the strap is fitted to the bag and the leash can be formed by securing one releasable clip to the bag to form the handle from a loop of the strap and by leaving the other releasable clip free for attaching to a pet.

The handle of the leash may be formed by attaching one of the releasable clips to the strap at an intermediate position between the releasable clips.

Alternatively, the strap may include a releasable clip at one end and a clip point at the other end so that the releasable clip and the clip point can be connected to form the carrier bag and the bag may include a releasable clip for connection to the clip point to form the handle of the leash.

In one embodiment of each aspect, the strap may be releasably fittable to the bag so that the strap can be separated from the bag. In this regard, the bag may include a releasable fitting. For example, the bag may include a pair of spaced-apart rings or a channel through which the strap is fed, co-operable press-fit formations on the strap and the bag or the bag may include a flap that can be folded over and releasably retained in contact with the bag such that a sleeve is formed for retaining the strap.

In an alternative embodiment of each aspect, the strap is fixed to the bag. In this embodiment, the handle may comprise a loop formed in the bag. This embodiment may include the strap having a releasable clip at a free end and include a clip point on the bag such that the carrier bag is formed by attaching the releasable clip to the clip point on the bag. In a variation of this embodiment, the strap may include a free end with a releasable clip and a fixed loop formed in the opposite end as the handle of the leash and wherein the fixed loop includes a clip point for connecting with the releasable clip to form the carrier bag.

Other aspects, features, and advantages will become apparent from the following detailed description when taken in conjunction with the accompanying drawings, which are a part of this disclosure and which illustrate, by way of example, principles of inventions disclosed.

### BRIEF DESCRIPTION OF THE DRAWINGS

Notwithstanding any other forms which may fall within the scope of the disclosure as set forth in the Summary, specific embodiments will now be described, by way of example only, with reference to the accompanying drawings in which:

FIG. 1 is an isometric view of a strap and a bag for a pet accessory in accordance with an embodiment of the invention;

FIG. 2 is an isometric view of an assembly of the strap and the bag of FIG. 1 in the form of a leash;

FIG. 3 is an isometric view of a pet accessory according to another embodiment of the invention.

### DESCRIPTION OF EMBODIMENTS

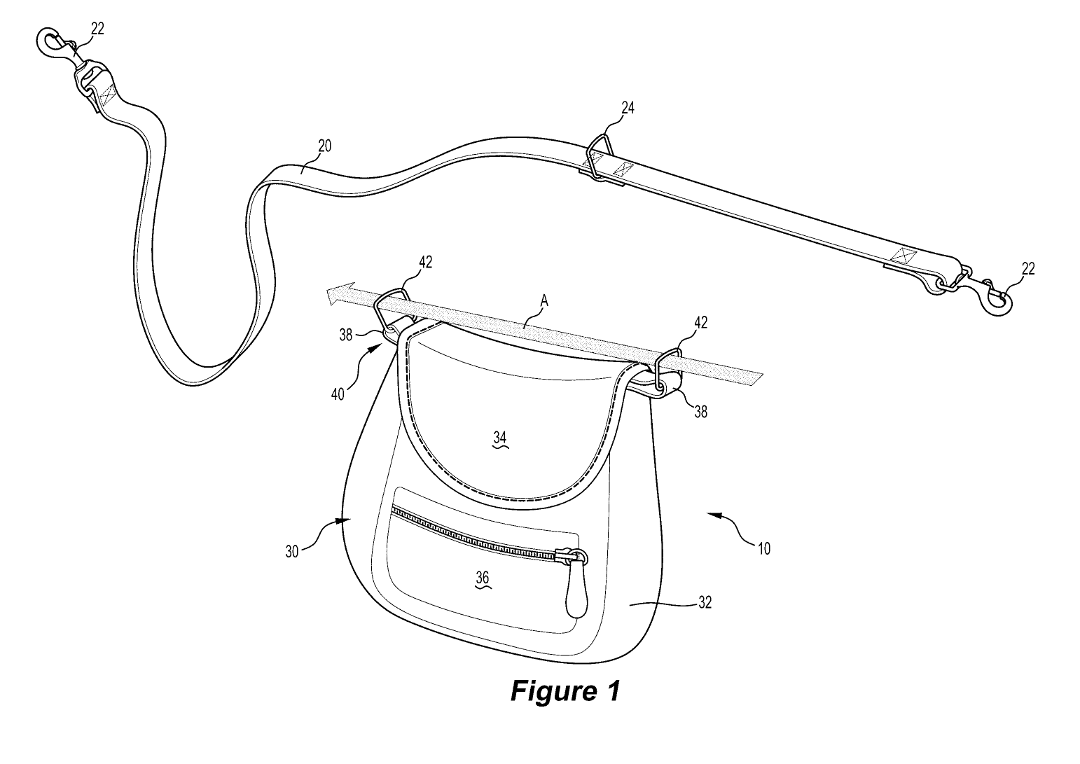

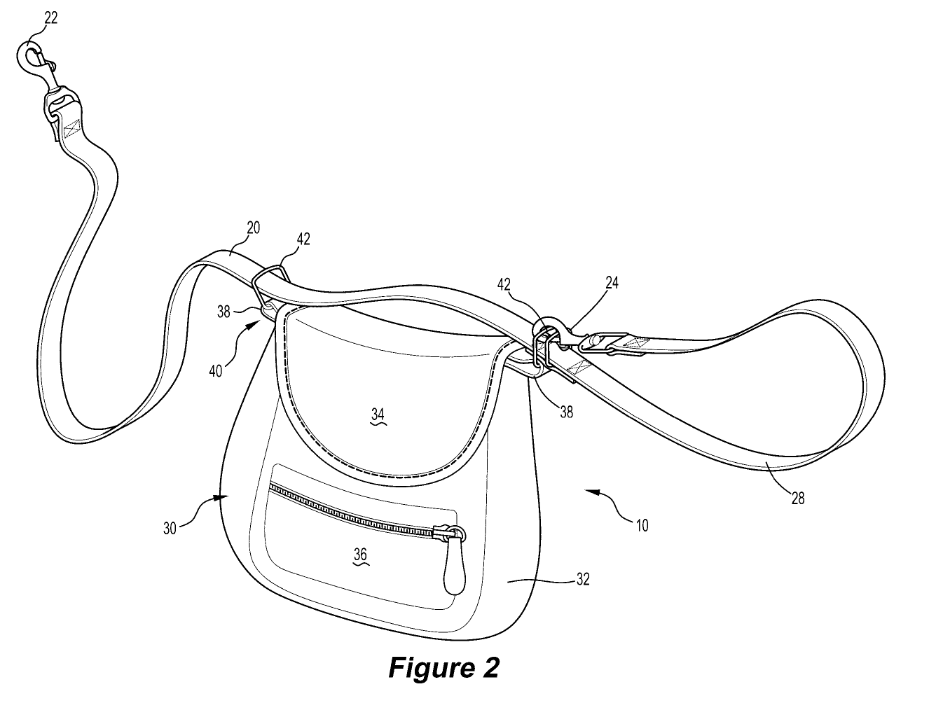

Having regard to FIG. 1, a pet accessory 10 is shown as comprising a strap in the form of a lead 20 having sufficient length to be used as a leash and a bag 30 for containing objects. Generally speaking, the lead 20 is fitted with the bag 30 such that the pet accessory 10 is adaptable to form a carry bag whereby the lead 20 forms a loop for carrying the bag and to form a pet leash (FIG. 2) with a handle in the form of a handle loop 28.

The lead 20 includes releasable clips in the form of spring-loaded clips 22 at each end of the lead 20. Specifically, the spring-loaded clips 22 are attached to D-rings which are, in turn, held in loops sewn into the ends of the lead 20. The releasable clips may be caribeenas or any other suitable releasable clip known in the art for withstanding tensile forces applied by a pet, such as a dog, pulling on the lead 20. Additionally, the lead 20 may be formed of suitable material withstanding tensile forces applied by a pet, such as a dog, pulling on the lead 20. Such materials include, but are not limited to, plastics (for example in the form of webbing or braided ropes), leather and woven cotton, such as canvas.

The lead 20 further includes a clip point located intermediate the spring-loaded clips 22 in the form a D-ring 24 sewn into a fixed position. It will be appreciated, however, that the D-ring 24 may be replaced with any other suitable element that is co-operable with the spring-clip 22 (or whatever alternative form the releasable clip may take). For example, the clip point may comprise an eyelet formed in the lead 20 so that part of the spring-loaded clip 22 or other form of releasable clip may pass through the eyelet to enable the spring-loaded clip or other form of releasable clip to be releasably secured the eyelet.

The bag 30 comprises a body 32 defining an interior volume for containing objects such as loaded dog poo bags, sunscreen, dog toys, snacks, mobile phone and wallet or purse. The body includes an access flap 34 that expends over the body to cover an opening (not shown) for the purposes of closing the opening and securing the objects within the interior volume. Partitions within the interior volume may be provided to segment the interior volume into compartments for separating objects within the volume. The partitions, therefore, assist with organizing objects within the interior space.

The body 32 may further include a zip-closable pocket 36 that is accessible from the exterior of the body 32. This pocket 36 is readily accessible and therefore can be used for storing frequently used objects.

Upper lateral corners of the body 30 are fitted with shoulders 38 in the form of short strips material sewn to the body so as to form respective loops 40 with the body 32 at each shoulder 38. Each loop 40 is fitted with a ring 42 that has an internal cross-section which is dimensioned to receive the lead 20.

As shown in FIG. 1, the lead 20 is threaded through each ring 42 in the direction of the arrow A until the D-ring 24 abuts one of the rings 42. From this position, the pet accessory can be formed as a carrier bag by connecting the spring-clips 22 together so that the lead 20 forms a loop which passes through the rings 42. Owing to the length of the lead 20, the carrier bag can be worn over the shoulder of a wearer so that the bag 30 hangs at waist or hip height. Alternatively, the pet accessory 10 can be slung across the torso of the wearer so that the lead 20 crosses over one shoulder of the wearer and the bag sit around the waist or hip of the wearer on their side opposite to the shoulder. In each case, the wearer is able to carry the pet accessory 10 hands-free so that they can engage in a range of activities that they could not otherwise partake in if one hand was occupied by holding a leash or bag.

The pet accessory is adaptable, however, to form a pet leash by uncoupling the spring-loaded clips 22 and connecting the spring-loaded clip which is proximate the D-ring 24 to the D-ring 24 and the adjacent ring 42 to form a handle 28 in the lead 20 (FIG. 2). This also retains the bag 30 on the lead 20 at a location adjacent the handle 28. In other words, the bag 30 is prevented from sliding along the lead 20 to the spring-clip 22 at the opposite end of the lead 20. The spring-loaded clip 22 at the free end of the lead 20 can be connected to a clip point on a collar or harness fitted to a dog so that the pet accessory 10 can be used as a leash to restrain the dog.

The adaptability of the pet accessory 10 between a carrier bag and a leash provides considerable convenience for carrying loaded dog poo bags because they can be retained within the bag 30 regardless of the form adopted for the pet accessory 10. Doing so avoids the unpleasantness associated with carrying a loaded dog poo bag in the hand.

An advantage of having the lead 20 releasably coupled to the bag 30 is that the lead can be separated and used without the bag 30 if desired. It will be appreciated, however, that the rings 42 may be replaced with alternative elements for releasably fitting the lead 20 to the bag 30. For example, the lead 20 may be releasably fitted to the bag 30 by co-operable press-fit formations on the lead 20 and the bag 30 or the bag 30 may include a flap that can be folded over and releasably retained in contact with the bag 30 such that a sleeve is formed for retaining the strap.

One alternative form of the pet accessory 10, which provides the same level of convenience, involves a section of the lead 20 that is equivalent to the section extending between the rings 42 being permanently coupled to the bag 30.

In a further alternative, the lead 20 is permanently coupled to the bag 30, but one end of the lead is permanently formed as a handle. Accordingly, there is no need for the D-ring 24 or the rings 42. The handle includes a clip point (as described above) for connecting to the releasable clip on the free end of the lead 20 so that the pet accessory can be used as a carrier bag.

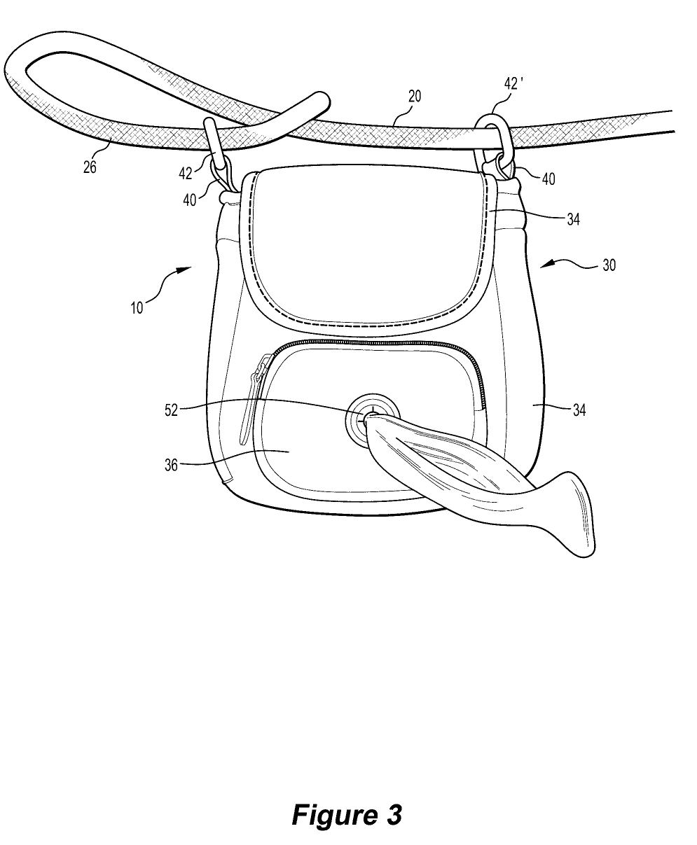

FIG. 3 shows an alternative embodiment of the pet accessory. For convenience, like features are denoted by like reference numerals. The embodiment in FIG. 3 differs in that rings 42 have spring-loaded gates that enable the lead 20 to be passed into the inside of the rings 42. Similarly, the gates can be opened to allow the lead 20 to be released from the rings 42. For convenience, the rings 42 with gates will be referred to as “gated-rings 42”.

As shown in FIG. 3, the lead 20 is a conventional pet leash in that it includes a permanent loop handle 26. Although not shown in FIG. 3, the lead 20 also includes a length that is suitable for the lead to be used as a pet leash and further includes a spring-clip 24 at a free end for attaching the lead to a collar or a harness fitted to a pet. The lead 20 is fitted to the bag 30 in the manner shown in FIG. 3. That is, a portion of the lead that forms the permanent hand loop 26 is fitted inside one of the gated-rings 42 by opening the gate, passing the loop 26 into the ring 42 and then closing the gate. It will be appreciated that the gated-ring 42 is required because the bag 30 is then mechanically locked with the lead 20 via the gated-ring 42. If the lead 20 were threaded through the gated-ring 42, there would be nothing fixing the bag 30 to the lead 20, so there is a risk that it might become unthreaded and, therefore, fall off. Additionally, there is nothing stopping the bag 30 from slipping down the lead 20 to the spring-clip 24, out of the reach of the user.

The bag 30 includes another gated-ring 42′ spaced from the other gated-ring 42 so that a portion of the lead 20 adjacent the hand loop 26 can be captured as shown in FIG. 3. In this manner, the bag 30 is prevented from swinging about the gated-ring 42, so the incidence of the bag 30 swinging and hitting the user's hand is reduced. This gated-ring 42′ may, however, be replaced with another form of releasable link, such as hook and loop fastener on the lead 20 and the bag 30, a sleeved formed in the bag 30 or press-fit studs on the lead 20 and the bag 30.

The bag 30 further includes a side pocket 50 with a dispensing aperture 52 that is formed to allow dog poo bags to be pulled from the side pocket 36 without having to open the pocket. This is advantageous where the dog poo bags are linked by perforated sections so that one bag is torn from the remainder. Pulling a dog poo bag through the aperture 52 to make the perforated section available so a leading bag can be removed causes a portion of the trailing bag to protrude through the aperture 52 and, therefore, it is easily accessible when needed.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the pet accessory as disclosed herein.

In the foregoing description of preferred embodiments, specific terminology has been resorted to for the sake of clarity. However, the invention is not intended to be limited to the specific terms so selected, and it is to be understood that each specific term includes all technical equivalents which operate in a similar manner to accomplish a similar technical purpose. Terms such as “front” and “rear”, “inner” and “outer”, “above”, “below”, “upper” and “lower” and the like are used as words of convenience to provide reference points and are not to be construed as limiting terms. The terms “vertical” and “horizontal” when used in reference to the trim throughout the specification, including the claims, refer to orientations relative to the normal operating orientation of the pet accessory disclosed herein.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, for example, aspects of one embodiment may be combined with aspects of another embodiment to realize yet other embodiments. Further, each independent feature or component of any given assembly may constitute an additional embodiment.

1. A pet accessory comprising:
(a) a strap having sufficient length to be used as a leash and having a releasable catch at a first end for attaching the strap to a pet;
(b) a bag defining an interior volume for containing objects; and
(c) attachment means that is adapted to attach the bag to the strap such that the pet accessory is adaptable to form a carry bag whereby the strap forms a handle or shoulder strap for carrying the bag and to form a pet leash with the bag attached and with the strap forming a hand loop in a portion of the strap opposite to the first end for restraining a pet.

2. The pet accessory of claim 1, wherein the strap includes a releasable catch at a second end and a clip point near the second end so that the releasable clip at the second end can be held by the attachment means and the clip point simultaneously to form the hand loop of the pet leash.

3. The pet accessory of claim 2, wherein the strap is able to pass through the attachment means so that the clip point and the attachment means are able to be held by the releasable catch at the second end of the strap to form the pet leash and the releasable catches on the first end and the second end can be arranged to hold each other independent of the clip point and the attachment means to form the carry bag.

4. The pet accessory of claim 1, wherein the strap is a pet leash having a fixed loop handle at a second end and wherein the strap is able to pass through the attachment means such that the bag is attached to the pet leash and the accessory operates as a pet restraint and the releasable catch can be arranged to hold the fixed loop handle such that pet leash forms the handle or shoulder strap for carrying the bag.

5. The pet accessory of claim 1, wherein the attachment means comprises an endless ring that is fixed to the bag or the attachment means is a ring having an openable gate through which objects, such as the strap, may be passed to be contained within the ring.

6. The pet accessory of claim 1, wherein the attachment means comprises a support member and an endless ring that is fixed to the bag.

7. The pet accessory of claim 6, wherein the support member is a sleeve formed in the bag and through which sleeve the strap may be passed to suspend the bag from the strap.

8. The pet accessory of claim 6, wherein the support member is another endless ring that is fixed to the bag and spaced from the other endless ring.

9. The pet accessory of claim 6, wherein the support member is press studs or hook and loop fastener.

10. The pet accessory of claim 1, wherein the strap includes a first clip point at the second end and a second clip point near the second end and the attachment means is a releasable catch that is located to hold the second clip point so that, with the strap passed through the attachment means, the two clip points can be held by the releasable catch on the bag to form the hand loop of the pet leash and the releasable clip on the first end can hold the clip point on the second end to form the carry bag.

11. The pet accessory of claim 10, wherein the attachment means is a permanent fixing.
